(19) United States
(12) Patent Application Publication
(10) Pub. No.: US 2007/0230879 A1
(43) Pub. Date: Oct. 4, 2007

(54) Armored fiber optic cable having a centering element and methods of making

(76) Inventors: Warren W. McAlpine, Hickory, NC (US); Scott A. McDowell, Connelly Springs, NC (US); Rodney M. Burns JR., Conover, NC (US); James A. Register III, Hickory, NC (US)

Correspondence Address: CORNING CABLE SYSTEMS LLC, C/O CORNING INC., INTELLECTUAL PROPERTY DEPARTMENT, SP-TI-3-1, CORNING, NY, 14831, US

(21) Appl. No.: 11/395,405

(22) Filed: Mar. 31, 2006

(51) Int. Cl. G02B 6/44

(52) U.S. Cl. 385/101; 385/113

(57) ABSTRACT

Armored fiber optic cables and methods for making are disclosed that include an armor layer generally surrounding a fiber optic cable that includes at least one optical waveguide and a cable jacket. The cable jacket has an outer diameter and armor layer has an inner surface, wherein a gap exists between the outer diameter of the cable jacket and the inner surface of the armor layer. The armored fiber optic cable further includes a centering element disposed in the gap between the fiber optic cable and the armor layer. The centering element generally inhibits the fiber optic cable from moving away from a middle of the armored fiber optic cable towards the inner surface of the armor layer during winding of the armored fiber optic cable, thereby inhibiting wavy armor and/or preserving the optical performance of the at least one optical waveguide.

### FIELD OF THE INVENTION

The present invention relates generally to an armored fiber optic cable and methods for making the same. More particularly, the present invention relates to armored fiber optic cables having a centering element for keeping the cable in the middle of the armor during manufacturing.

### BACKGROUND OF THE INVENTION

Communication networks are used to transport a variety of signals such as voice, video, data transmission, and the like. As communication applications required greater bandwidth, communication networks switched to cables having optical fibers since they are capable of transmitting an extremely large amount of bandwidth compared with a copper conductor. Moreover, a fiber optic cable is much lighter and smaller compared with a copper cable having the same bandwidth capacity.

Consequently, fiber optic cables are used in a wide variety of applications and must meet specific criteria for the given application while preserving optical performance. For instance, fiber optic cables may be used in indoor, outdoor, or indoor/outdoor applications. These different applications have different requirements for satisfying the operating conditions for the fiber optic cable and/or preserving optical performance. By way of example, indoor fiber optic cables require meeting minimum standards for flame and/or smoke propagation since they are intended for use within a building. Similarly, outdoor applications expose fiber optic cables to environmental effects such as temperature variations and/or water. In other applications, fiber optic cables may require a robust covering for protecting the fiber optic cable from open flames and/or mechanical forces such as tensile or crush forces.

One known way for protecting a fiber optic cable from open flames and/or mechanical forces is by using a rugged armor layer disposed about the fiber optic cable for protecting the same. Generally speaking, an armor layer inhibits open flames from directly reaching the fiber optic cable and may delay the production of smoke from the cable when exposed to open flames if the armor layer is the outside layer. Additionally, the armor layer generally increases the ability of the fiber optic cable to withstand crush and/or tensile forces.

However, manufacturing fiber optic cables with an armored layer can present certain challenges for preserving optical performance. For instance, one armored fiber optic cable design uses an interlocking armor loosely disposed about the fiber optic cable so the interlocking armor may be easily removed if desired. Because the interlocking armor is loosely disposed about the fiber optic cable the interlocking armor can have a length that is different from the fiber optic cable, thereby causing the formation of wavy armor along the longitudinal length thereof. In order to inhibit the formation of wavy armor during manufacturing, relatively high processing tensions are used. But using relatively high processing tensions can cause other problems during manufacturing. By way of example, the optical fibers of the armored fiber optic cable may have relatively high optical attenuation due to the application of relatively high processing tensions. Usually, after a period of time the optical fibers relax from the application of relatively high processing tensions and the optical attenuation values return to acceptable levels, but some of the cables may need to be temperature cycled in order to relax the optic fibers, thereby relieving the process induced strain. The present invention addresses the problems associated with manufacturing armored fiber optic cables where the armor is loosely disposed about the fiber optic cable.

### SUMMARY OF THE INVENTION

One aspect of the present invention is directed to an armored fiber optic cable having a fiber optic cable having at least one optical waveguide and a cable jacket and an armor layer generally surrounds the fiber optic cable with a centering element therebetween. The cable jacket has an outer diameter and armored layer has an inner surface, wherein a gap exists between the outer diameter of the cable jacket and the inner surface of the armor layer. The centering element is disposed in the gap between the fiber optic cable and the armor layer for inhibiting the fiber optic cable from moving away from a middle of the armored fiber optic cable towards the inner surface of the armor layer during winding of the armored fiber optic cable. Consequently, the optical performance of the at least one optical waveguide is preserved by inhibiting the strain placed on the optical fiber(s) during manufacturing.

Another aspect of the present invention is an armored fiber optic cable having a fiber optic cable, a centering element, and an armor layer. The centering element is disposed in a gap between an outer diameter of the fiber optic cable and an inner surface of the armor layer. The centering element surrounds less than an entire circumference of the fiber optic cable, wherein the centering element generally inhibits the fiber optic cable from moving away from a middle of the armored fiber optic cable towards the inner surface of the armor layer during winding of the armored fiber optic cable, thereby preserving the optical performance of the at least one optical waveguide.

Yet another aspect of the present invention is directed to an armored fiber optic cable having a fiber optic cable having at least one optical waveguide, at least one strength element and a cable jacket and an interlocking armor layer generally surrounds the fiber optic cable with a centering element therebetween. The cable jacket has an outer diameter and armored layer has an inner surface, wherein a gap exists between the outer diameter of the cable jacket and the inner surface of the armor layer. The centering element is disposed in the gap between the fiber optic cable and the armor layer for inhibiting the fiber optic cable from moving away from a middle of the armored fiber optic cable towards the inner surface of the armor layer during winding of the armored fiber optic cable, thereby preserving the optical performance of the at least one optical waveguide.

It is to be understood that both the foregoing general description and the following detailed description present embodiments of the invention, and are intended to provide an overview or framework for understanding the nature and character of the invention as it is claimed. The accompanying drawings are included to provide a further understanding of the invention, and are incorporated into and constitute a part of this specification. The drawings illustrate various embodiments of the invention, and together with the description serve to explain the principals and operations of the invention.

### BRIEF DESCRIPTION OF THE DRAWINGS

FIG. 1 is a perspective view of a conventional armored fiber optic cable.

FIG. 2 is a partial cut-away schematic representation of the conventional armored fiber optic cable of FIG. 1 being bent over a capstan during the manufacturing process.

FIG. 3 is a cross-sectional view of the conventional fiber optic cable on the capstan of FIG. 2 taken along the line 3-3.

FIG. 4 is a cross-sectional view of an armored fiber optic cable according to the present invention.

FIG. 5 is a cross-sectional view of the armor fiber optic cable of FIG. 4 disposed a capstan during the manufacturing process.

FIG. 6 is a cross-sectional view of the centering element of the fiber optic cable of FIG. 4.

FIG. 7 is a cross-sectional view of another armored fiber optic cable according to the present invention.

FIG. 8 is a flowchart showing exemplary steps for manufacturing a fiber optic cable according to the present invention.

### DETAILED DESCRIPTION OF THE INVENTION

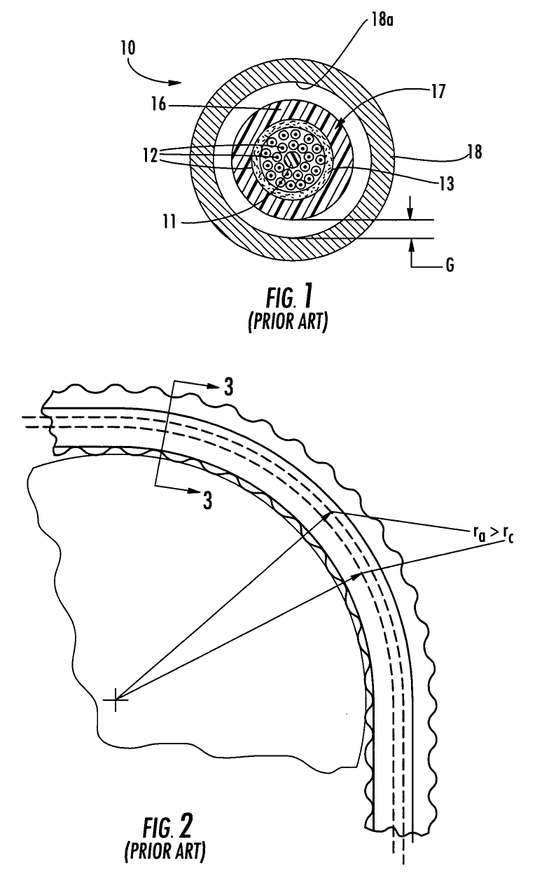

Reference will now be made in detail to the present preferred embodiments of the invention, examples of which are illustrated in the accompanying drawings. Whenever possible, the same reference numerals will be used throughout the drawings to refer to the same or like parts. FIG. 1 depicts a perspective view of a conventional armored fiber optic cable 10 (hereinafter armored cable 10) having a fiber optic cable 17 and an interlocking armor layer 18 therearound for providing additional protection to fiber optic cable 17. Fiber optic cable 17 includes a central strength member 11 having a plurality of optical waveguides such as optical fibers 12 having a buffer layer (not numbered) stranded therearound, a plurality of strength elements 13, and a cable jacket 16. As shown, a gap G exists between an outer diameter (not numbered) of the cable jacket 16 and an inner surface 18a of the interlocking armor layer 18. Using gap G between fiber optic cable 17 and interlocking armor layer 18 eases the removal of relatively long lengths of interlocking armor layer from fiber optic cable 17. In other words, the armor layer 17 is not bound to a portion of fiber optic cable 17 so it can easily be removed if desired. However, gap G also allows fiber optic cable 17 to move radially within the interlocking armor layer 18 such as during manufacturing.

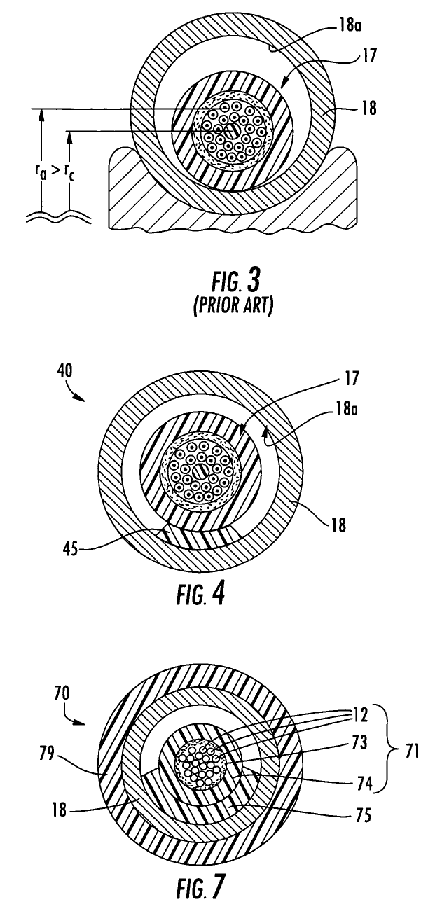

More specifically, FIG. 2 depicts a partial cut-away schematic representation of conventional armored fiber optic cable 10 being bent over, for instance, an exemplary capstan 22 during the manufacturing process. Moreover, similar effects occur using other cable manufacturing equipment that places the fiber optic cable in a bend such as caterpuller, reel, or the like. As shown, gap G allows fiber optic cable 17 to move toward the inside surface 18a of interlocking armor layer 18 when relatively high tensions are applied so that the bending radii of the fiber optic cable 17 and interlocking armor layer 18 are different. Stated another way, a bending radius of the interlocking armor layer rₐ is greater than a bending radius of the fiber optic cable r_{c}. This difference in bending radii is also depicted in FIG. 3, which shows a cross-sectional view taken along line 3-3 of the conventional armored fiber optic cable 10 on capstan 22. Consequently, the different bending radii between interlocking armor layer 18 and fiber optic cable 17 can cause a length difference between the interlocking armor layer and fiber optic cable 17 (i.e., the length of fiber optic cable 17 is shorter than interlocking armor layer 18), thereby allowing the formation of wavy armor when the armor fiber optic cable is unspooled from the reel. Stated another way, since fiber optic cable 17 and interlocking armor layer 18 are not coupled together fiber optic cable 17 they can travel at different speeds to cause wavy armor.

The present invention solves the problems of wavy armor and/or optical attenuation issues caused by loosely forming the armor layer about the fiber optic cable with a gap therebetween. More specifically, the present invention uses a centering element disposed between the fiber optic cable and the armor layer for inhibiting fiber optic cable from moving away from the middle of the armor layer disposed therearound. In other words, the centering element inhibits the fiber optic cable from moving away from the middle of the armor layer while still allowing a gap between the armor layer and the fiber optic cable so that the armor layer can be easily removed.

FIG. 4 is a cross-sectional view of an armored fiber optic cable 40 according to the present invention. As shown, armored fiber optic cable 40 includes fiber optic cable 17, a centering element 45, and an armor layer 18. Centering element 45 is disposed between fiber optic cable 17 and armor layer 18 for inhibiting fiber optic cable 17 from moving toward an inner surface 18a of armor layer 18. Centering element may also have different orientations within the armor layer such as being relatively straight or helically wrapped about fiber optic cable 40 with a suitable pitch. By way of example, FIG. 5 depicts a cross-sectional view of armor fiber optic cable 40 disposed on capstan 22 such as during manufacturing of the same. As depicted, the bending radii of armor layer 18 and fiber optic cable 17 are the same or nearly equal so that they travel at the same speed about the capstan. Consequently, the formation of wavy armor and/or optical attenuation issues are advantageously inhibited since fiber optic cable 17 is inhibited from moving towards inner surface 18a of armor layer 18.

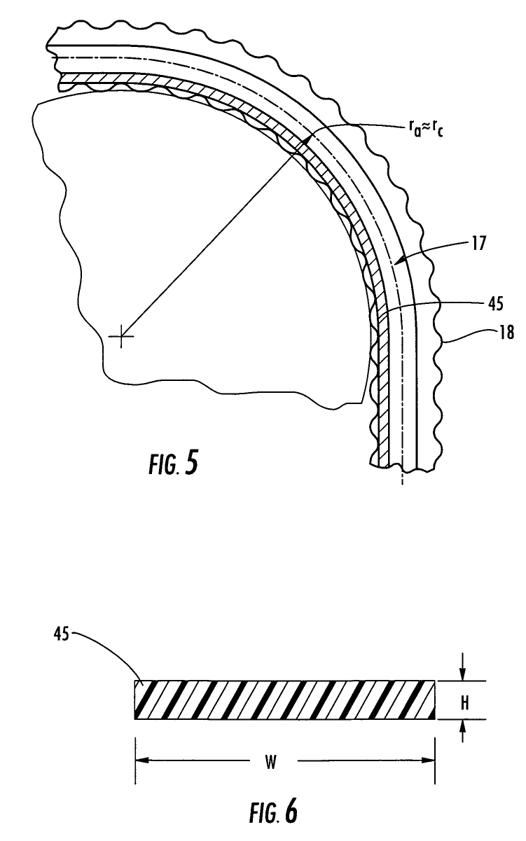

FIG. 6 is a cross-sectional view of centering element 45 of armored fiber optic cable 40. Centering element 45 may be formed from any suitable material such as a polymer, metal, paper, or the like formed into a longitudinal tape. For instance, suitable polymers include polyethylene, polypropylene, polyvinylchloride, PVDF, mylar, blends thereof, or the like. In other embodiments, centering element 45 may be formed from a metal tape such as steel, aluminum, etc. Centering element 45 is shown laid out flat and has a width W and a height H. Height H is selected so that fiber optic cable is maintained at or near the center of armor layer 48. Illustratively, if gap G is about 5 millimeters, then height H of centering element is selected so that it is about 5 millimeters. In one embodiment, width W of centering element 45 is selected so that it surrounds less than an entire circumference of fiber optic cable 17 such as about 1/10 of the circumference of the fiber optic cable to reduce the amount of material used, thereby reducing expense. However, any suitable width of centering element is possible using the concepts of the present invention.

In one embodiment, fiber optic cable 17 is flame-retardant so it is suitable for indoor use such as plenum, riser, and/or LSZH (low smoke zero halogen) applications. Fiber optic cable 17 is made flame-retardant by, for example, using suitable combinations of polymers for the buffer layer disposed about each individual optical fiber and/or the cable jacket. By way of example, the buffer layer about the individual optical fiber is PVC and the cable jacket is also formed of a PVC; however, other suitable materials may be used to create a flame-retardant cable. Likewise, the centering element may also be formed of a flame-retardant material such as a PVC or the like.

As depicted, armored fiber optic cable 40 uses an interlocking armor for armored layer 18, but any suitable armor layer may be used. The interlocking armor layer is spirally wrapped about fiber optic cable 17 and successive wraps of the armor attach to the previous wrap, thereby making a relatively flexible armor layer, while inhibiting over-bending of the same since the interlocking armor has a minimum bending radius. Suitable metal tapes for forming interlocking armor is available from Alcan of Canada.

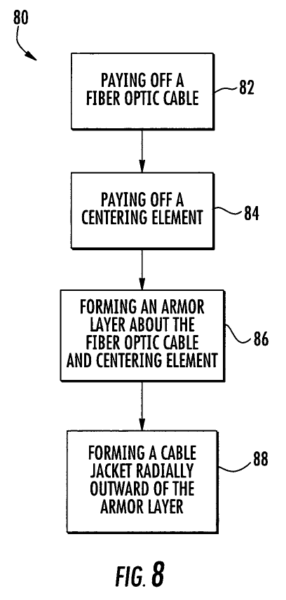

FIG. 7 is a cross-sectional view of armored fiber optic cable 70 according to another embodiment of the present invention. Armored fiber optic cable 70 includes a fiber optic cable 71, a centering element 75, an armor layer 78, and a second jacket 79 disposed radially outward of armor layer 18. In this embodiment, cable 71 includes a plurality of optical fibers 12 that exclude a buffer layer therearound. In other words, optical fibers 12 are the coatings thereof to contact each other. The plurality of optical fibers 12 are arranged in a bundle and secured with a binder (not visible) such as a thread, paper tape, or the like. A plurality of strength members 73 such as aramid or fiberglass are stranded about the bundle for providing tensile strength to fiber optic cable 71 so that some of the optical fibers 12 may contact some of the strength members 73. A cable jacket 74 is disposed about the plurality of strength members 73 for providing protection for fiber optic cable 71.

In this embodiment, the width W of centering element 75 is selected to so that contacts a larger arc of the fiber optic cable than the embodiment shown in FIG. 4. In other words, the width W of centering element 75 is selected to contact slightly less than have of the periphery of fiber optic cable 71. Additionally, armored fiber optic cable 70 includes a second jacket disposed radially outward of armor layer 18. Likewise, other embodiments of the present invention may include a second jacket radially outward of the armor layer.

Exemplary steps for making a fiber optic cable according to the present invention are shown in FIG. 8. Manufacturing process 80 includes a step 82 of paying off a fiber optic cable, a step 84 of placing a centering element adjacent to the fiber optic cable, and a step 86 of forming an armor layer about the fiber optic cable and the centering element. Optional steps may include a step 88 of forming a cable jacket radially outward of the armor layer or a step of having a larger tension on the centering element than the cable when paying off. Keeping a higher tension on the centering element maintains the position of the centering element against the armor during manufacturing.

It will be apparent to those skilled in the art that various modifications and variations can be made to the present invention without departing from the spirit and scope of the invention. For instance, the concepts described herein can be applied to any suitable fiber optic cable designs. Likewise, fiber optic cables may include other suitable cable components such as ripcords. Thus it is intended that the present invention cover the modifications and variations of this invention provided they come within the scope of the appended claims and their equivalents.

What is claimed is:

1. An armored fiber optic cable comprising:
a fiber optic cable, the fiber optic cable having at least one optical waveguide and a cable jacket, the cable jacket having an outer diameter;
an armor layer, the armor layer generally surrounding the fiber optic cable and has an inner surface, wherein a gap exists between the outer diameter of the cable jacket and the inner surface of the armor layer; and
a centering element, the centering element being disposed in the gap between the fiber optic cable and the armor layer, wherein in the centering element generally inhibits the fiber optic cable from moving away from a middle of the armored fiber optic cable towards the inner surface of the armor layer during winding of the armored fiber optic cable, thereby preserving the optical performance of the at least one optical waveguide.

2. The armored fiber optic cable of claim 1, wherein the centering element surrounds less than an entire circumference of the fiber optic cable.

3. The armored fiber optic cable of claim 1, wherein the centering element is formed from a flame-retardant material.

4. The armored fiber optic cable of claim 1, wherein the armored layer is formed from an interlocking armor.

5. The armored fiber optic cable of claim 1, the fiber optic cable further including at least one strength element.

6. The armored fiber optic cable of claim 1, the at least one optical fiber having a buffer layer thereon.

7. The armored fiber optic cable of claim 1, wherein the centering element has a width that surrounds less than half of a circumference of the fiber optic cable.

8. The armored fiber optic cable of claim 1, wherein the fiber optic cable is flame retardant.

9. The armored fiber optic cable of claim 1, wherein the fiber optic cable has a central strength member.

10. The armored fiber optic cable of claim 1, further comprising a second cable jacket disposed radially outward of the armor layer.

11. An armored fiber optic cable comprising:
a fiber optic cable, the fiber optic cable having at least one optical waveguide and a cable jacket, the cable jacket having an outer diameter;
an armor layer, the armor layer generally surrounding the fiber optic cable and having an inner surface, wherein a gap exists between the outer diameter of the cable jacket and the inner surface of the armor layer; and
a centering element, the centering element being disposed in the gap between the fiber optic cable and the armor layer and surrounds less than an entire circumference of the fiber optic cable, wherein the centering element generally inhibits the fiber optic cable from moving away from a middle of the armored fiber optic cable towards the inner surface of the armor layer during winding of the armored fiber optic cable, thereby preserving the optical performance of the at least one optical waveguide.

12. The armored fiber optic cable of claim 11, wherein the centering element is formed from a flame-retardant material.

13. The armored fiber optic cable of claim 11, wherein the armored layer is formed from an interlocking armor.

14. The armored fiber optic cable of claim 11, the fiber optic cable further including at least one strength element.

15. The armored fiber optic cable of claim 11, the at least one optical fiber having a buffer layer thereon.

16. The armored fiber optic cable of claim 11, wherein the centering element has a width that surrounds less than half of a circumference of the fiber optic cable.

17. The armored fiber optic cable of claim 11, wherein the fiber optic cable is flame retardant.

18. The armored fiber optic cable of claim 11, wherein the fiber optic cable has a central strength member.

19. The armored fiber optic cable of claim 11, further comprising a second cable jacket disposed radially outward of the armor layer.

20. A method of making an armored fiber optic cable including the steps of:
paying off a fiber optic cable;
paying off a centering element and placing the centering element adjacent to the fiber optic cable for maintaining the position of the fiber optic cable;
forming an armor layer about the fiber optic cable and the centering element, wherein a gap exists between the outer diameter of the fiber optic cable and an inner surface of the armor layer and the centering element positions the fiber optic cable in the middle of the armor layer.

21. The method of claim 20, further comprising a step of forming a cable jacket radially outward of the armor layer.

22. The method of claim 22, further comprising the step of tensioning the centering element with a larger tension than the fiber optic cable.
